(19) United States
(12) Patent Application Publication
(10) Pub. No.: US 2010/0159090 A1
(43) Pub. Date: Jun. 24, 2010

(54) INJECTION OF VISCOUS MATERIALS INTO MUSCLE MEAT

(76) Inventor: Leo D. Pedersen, Danville, CA (US)

Correspondence Address: Bay Area Technolgy Law Group PC, 500 Sansome Street, Suite 404, San Francisco, CA, 94111, US

(21) Appl. No.: 12/340,901

(22) Filed: Dec. 22, 2008

(51) Int. Cl. A23L 1/314

(52) U.S. Cl. 426/281; 99/532

(57) ABSTRACT

A method and device for dispersing a viscous material into muscle meat. Viscous material is introduced into a volumetric chamber which is capable of passing a measured amount of the viscous material into an injection needle which, in turn, is inserted within the muscle meat. The needle is sized and configured to insert the measured amount of viscous material in a pattern resembling the surrounding muscle flake of the muscle meat.

### TECHNICAL FIELD

A method and device for dispersing a viscous material into muscle meat. Viscous material is introduced into a volumetric chamber which is capable of passing a measured amount of the viscous material into an injection needle which, in turn, is inserted within the muscle meat. The needle is sized and configured to insert the measured amount of viscous material in a pattern resembling the surrounding muscle flake of the muscle meat.

### BACKGROUND OF THE INVENTION

Those in the food industry have wrestled for years with the need to introduce viscous material into the muscle meat of a food product, such as seafood. When a fish is caught, it is headed and gutted and eventually loined or filleted. In either case, significant muscle meat which could be consumed as part of the loin or filet is removed with the bone, skin and tendons resulting in product shrinkage and increased cost. There is thus a need to be able to capture such shrinkage and if, possible, reintroduce it into the loin or filet to replicate surrounding muscle flake and thus resemble an untreated loin or filet while of an increased weight due to reduced product shrinkage.

There is also a broader need to introduce viscous material into muscle meat not only for weight addition but also for flavorings or texture enhancement. Again, any such addition must not significantly detract from the appearance of an untreated product. This need exists not only regarding seafood but also with regard to meat and poultry.

Various meat tenderizers and applicators have been devised for inclusion of material for enhancing the weigh, texture and flavor of seafood, meat and poultry-based foods. These applications and related applicators are generally designed for the insertion of low solids marinates and related substrates. Such devices are unable to handle viscous substrates of the types described previously. Certainly, the typical prior art marinate applicators are incapable of introducing injectates having a solids concentration greater than 5% by weight. This is because prior art devices employ narrow feed channels introducing marinates that are distributed through a common header to enable the marinate to feed through multiple injection heads to accommodate assemble-line like production.

It is thus an object of the present invention to provide a method and device for dispersing a viscous material into muscle meat.

It is a further object of the present invention to provide a method and device for injecting a viscous material into muscle meat which, once introduced, replicates the muscle flake of the receiving body and is thus an imperceptible way to increase the product weight unbeknownst to a consumer.

These and further objects will become readily apparent when considering the following disclosure and appended claims.

### SUMMARY OF THE INVENTION

The present invention is directed to a method and device for dispersing viscous material into muscle meat. The viscous material is introduced into a volumetric chamber which is then introduced into an injection needle imbedded in the muscle meat. Pressure is applied to the viscous material in the volumetric chamber to feed a predetermined measured amount of viscous material into the injection needle. The viscous material is then injected as a predetermined measured amount into the muscle meat in a predetermined dispersion pattern. Preferably, the needle tip is of a specific configuration as discussed below to enhance appropriate muscle flake dispersion.

### BRIEF DESCRIPTION OF THE FIGURES

FIG. 1A is a cross-sectional side view of a schematic representation of a valve assembly in an open orientation useful in the practice of the present invention.

FIG. 1B is a cross-sectional side view of the valve assembly of FIG. 1A in a closed orientation.

FIG. 2 is a partial side view of the preferred injection needle tip useful in practicing the present invention.

### DETAILED DESCRIPTION OF THE INVENTION

As noted previously, it is the goal of the present invention to enable the injection of viscous materials to increase product weight and alter texture and flavor within a muscle product. It has been found that minimally coarsely ground fish muscle will after freezing and cooking reconstitute into a form very close to the original product. This enables the use of an apparatus that will deposit a predetermined amount of such material within a receiving body and disperse the injected volume in a desirable manner or shape. When depositing a viscous quantity of muscle meat, coarse grinding and cutting the meat from de-boners is all that is required. Removal of tendons and connective tissues is not necessary in practicing the present invention.

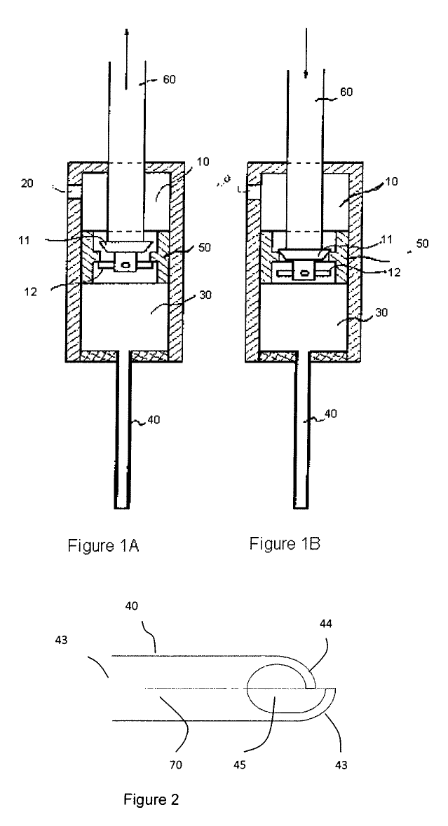

As an example of an assembly useful in practicing the present invention, reference is made to FIGS. 1A and 1B. The assembly of FIGS. 1A and 1B illustrate a valve assembly which can receive and inject coarsely triturated material while injecting the material into muscle meat as contemplated herein in amounts which are premeasured and controlled.

As noted by reference to FIGS. 1A and 1B, coarsely triturated material is received from a progressive displacement pump (not shown) entering injection chamber 10 through injectate feed port 20 under high pressure. The amount of pressure necessary will be dictated primarily by the viscosity of the injectate. As coarsely triturated materials are received through port 20, bushing 50 which is in contact with valve head 11 moves from its closed position of FIG. 1B to its open position of FIG. 1A. As bushing 50 moves downwardly, it rests and is stopped by cylindrical pin 12 allowing the passage of coarsely triturated material to pass therethrough in a measured amount until lower feed chamber 30 has been filled. The volume of lower feed chamber 30 dictates the measured amount of coarsely triturated material which is then injected within the muscle meat through injection needle 40 by the actuation of plunger 60 in a downward direction. In doing so, the assembly shown in FIGS. 1A and 1B, and particularly bushing 50 act as a one way valve enabling coarsely triturated material received within port 20 to progress to lower feed chamber 30 without such material entering upper injection chamber 10.

To facilitate the appropriate dispersion of the injectate into in the muscle meat, and ideally to do so as muscle flake, a specific injection needle is provided. In this regard, reference is made to FIG. 2. This needle design can simulate a muscle flake, inject a volume equal to the surrounding existing muscle flake in the receiving product recognizing, for example, that a fish fillet has a larger muscle flake near its head while toping off towards the tail. The needle is self cleaning and resistant to plugging by muscle fiber, tendons and “string” material. The needle must also be able to handle highly viscous material such as coarsely ground meat.

Injection needle 40 is depicted in the form of a cylinder having longitudinal axis 70 and includes material receiving end 42 and viscous material dispersing end 43. In its ideal configuration, injection needle 40 is provided with portion 44 acting to substantially block dispersing end 43 along longitudinal axis 70 while being provided with openings 45 in the needle sidewall to substantially inject the viscous material into the muscle meat in a pattern resembling surrounding muscle flake. Such a needle design can form new muscle flake through injection in a double horizontal pattern.

As noted, the ideal application for the present invention is to apply or introduce triturated meat and marinate with high solids content and viscous fluids, generally above 5% solids by weight into muscle meat and can form muscle flakes by injection that is nearly identical to that of the enhanced product. The invention can also be used to inject flavoring and texture enhancers such as partially dried or other water binding substrates to alter firmness and texture of the non-treated product. Injection needle 40 is ideally provided with an internal diameter of 3-8 mm receiving measured amounts of the viscous material from volumetric chamber 30. Injection needle 40 can apply viscous material from 30 to 90 degrees to the surface of the muscle meat in injectate volumes of 0.2 to 5 grams per injection. The injection of particular meat products such as trimmings can have high solids content from 5 to 100% of the injectate. Dispersion patterns can be determined by regulation of plunger velocity and needle tip configuration, such as that depicted in FIG. 2. Ideally, the viscous material is dispersed in the muscle meat at a pressure above 4 bar and at a rate of approximately 1 gram per second.

What is claimed is:

1. A method of dispersing viscous materials into muscle meat, said method comprising introducing said viscous material into a volumetric chamber, inserting an injection needle into said muscle meat, applying pressure to said viscous material in said volumetric chamber to feed a predetermined, measured amount of said viscous material into said injection needle, and injecting a predetermined measured amount of said viscous material into said muscle meat in a predetermined dispersion pattern.

2. The method of claim 1 wherein said viscous material comprises an injectate having a solids content of at least 5% by weight.

3. The method of claim 1 wherein said viscous material is dispersed into said muscle meat at a pressure above 4 bar and at a rate of approximately 1 gram per second through the tip said injection needle.

4. The method of claim 1 wherein said injection needle comprises a cylinder having a longitudinal axis, a viscous material receiving end and a viscous material dispersing end, said injection needle having a portion thereof substantially blocking said dispersing end at said longitudinal axis and having openings in its side wall to substantially inject said viscous material into said muscle meat in a pattern resembling surrounding muscle flake of said muscle meat.

5. The method of claim 1 wherein said injection needle is introduced into said muscle meat at an angle of approximately 30 degrees to 90 degrees to the surface thereof.

6. The method of claim wherein said viscous material comprises coarsely chopped muscle meat of the same variety as said muscle meat receiving said viscous material.

7. A device for dispersing a viscous material into muscle meat, said device comprising a volumetric chamber capable of receiving a predetermined measured amount of said viscous material, an injection needle located at an exit port of said volumetric chamber, a piston for feeding a measured amount of said viscous material to and through said injection needle upon depression thereof, said combination injection needle and volumetric chamber being sized to feed said viscous material into said muscle meat at a pressure above 4 bar and at a rate of approximately 1 gram per second through the tip of said injection needle.

8. The device of claim 7 wherein said injection needle is introduced to said muscle meat at an angle of approximately 30 degrees to 90 degrees to the surface thereof.

9. The device of claim 7 wherein said injection needle comprises the cylinder having a longitudinal axis, a viscous material receiving end and a viscous material dispersing end, said injection needle having a portion thereof substantially blocking said dispersing end at said longitudinal axis and having openings in its side wall to substantially inject said viscous material into said muscle meat in a pattern resembling surrounding muscle flake of said muscle meat.

10. The device of claim 7 wherein said viscous material comprises coarsely chopped muscle meat of the same variety as said muscle meat receiving said viscous material.

11. The device of claim 7 wherein said injection needle has an internal diameter of approximately 3 to 6 mm.
